(19) United States
(12) Patent Application Publication
(10) Pub. No.: US 2026/0205289 A1
(43) Pub. Date: Jul. 16, 2026

(54) SECURE INTEGRATION OF REAL-TIME STATUS INFORMATION IN APPLICATIONS

(71) Applicant: Truist Bank, Charlotte, NC (US)

(72) Inventors: Puneet Gulati, Cary, NC (US); Dilip Kale, Indian Land, SC (US)

(73) Assignee: Truist Bank, Charlotte, NC (US)

(21) Appl. No.: 19/021,644

(22) Filed: Jan. 15, 2025

(51) Int. Cl. H04L 9/14

(52) U.S. Cl. CPC H04L 9/14

(57) ABSTRACT

A cloud application programming interface (API) executing on one or more processors may receive a subscription request from an application, the subscription request includes indications of an authentication token, an event, an entity, and a callback link. A security platform may encrypt, the authentication token and provide the encrypted authentication token to the cloud API. An entity server associated with the entity may generate, a subscription that includes indications of the event, the callback link, the application, and the encrypted authentication token. The subscription may be stored in a subscription repository.

### BACKGROUND

Some applications allow users to perform operations related to payment accounts at various financial institutions. However, these applications may be provided by developers or other organizations that are not associated with these financial institutions. Therefore, when an operation is submitted, the user is unable to securely view the status, as the application has no visibility into the various stages of transaction processing.

### BRIEF SUMMARY

Embodiments of the present disclosure address the above needs and/or achieve other advantages by providing techniques to securely integrate real-time status information into applications.

In various embodiments, a method can be implemented to process a subscription request received by a cloud application programming interface (API) from an application. The subscription request includes an authentication token, an event, an entity, and a callback link. The security platform encrypts the authentication token and provides the encrypted token to the cloud API. The entity server then generates a subscription, which includes the event, the callback link, the application, and the encrypted authentication token, and stores it in a subscription repository.

This method can be described in a non-transitory computer-readable storage medium, which contains instructions to be executed by one or more processors. These instructions include receiving the subscription request, encrypting the authentication token, providing the encrypted token to the cloud API, generating the subscription, and storing it in the subscription repository.

The described method and system can be implemented using one or more processors and a memory storing the necessary instructions. When executed, the processors will receive the subscription request, encrypt the authentication token, provide the encrypted token to the cloud API, generate the subscription, and store it in the subscription repository. This implementation can be used in various cloud-based applications, such as event-driven systems or subscription services.

In some embodiments, a system may be configured to implement the method.

The features, functions, and advantages that have been discussed may be achieved independently in various embodiments of the present disclosure or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates a logic flow 400 in accordance with one embodiment.

FIG. 5 illustrates a logic flow 500 in accordance with one embodiment.

FIG. 6 illustrates a computing system 600 in accordance with one embodiment.

### DETAILED DESCRIPTION

Embodiments disclosed herein provide techniques to securely integrate real-time status information into external systems. Generally, the various systems of an entity (such as a financial institution, educational institution, business, etc.) may interface with one or more third-party applications. For example, third-party applications may be used to submit payments for invoices using an account at a financial institution. However, once the payment is submitted, the third-party application may not have further insight into the status of the payment. For example, conventional solutions do not provide visibility into the status of transaction processing to third-party applications.

Advantageously, embodiments disclosed herein provide solutions to securely integrate the real-time status information of various events via subscription and notification models. Generally, third-party applications may generate one or more subscription requests. A given subscription request may identify an event (e.g., a transaction identifier), a callback link (e.g., a uniform resource locator (URL)) where status information should be returned, one or more event types (e.g., payment processed, payment rejected, etc.), an entity processing the event, and an authentication token. A secure cloud platform may encrypt the authentication token and store the unencrypted authentication token. The cloud platform may provide the encrypted authentication token to the entity server, which generates and stores an indication of the subscription in a database. The subscription may include indications of the event, the callback link, the application, and the encrypted authentication token. Other parameters may be specified via the subscription request, e.g., subscriptions for entities, financial institutions, application developers, etc.

During processing of the event, a change in the status of the event may occur. For example, a transaction may be successfully processed. The successful processing of the transaction may trigger a notification. For example, when the status of the transaction changes in a database, a database trigger may cause generation of a synchronization workflow. The synchronization workflow may include the entity server identifying the changed status, identifying the subscription in the database, retrieving the subscription (including the encrypted credential), and providing a response including an indication of the status change (e.g., that the payment processed) to the cloud platform. The cloud platform may decrypt the authentication token and transmit an indication of the response (including the decrypted authentication token) to the callback link specified in the request. Doing so securely provides the status information to the application without exposing the secure authentication credentials to the entity server.

In some embodiments, the synchronization workflow may include one or more retries, e.g., when a notification is not successfully transmitted to one or more subscribers. The error may be logged in a database and automatically trigger one or more retries based on a configurable retry frequency. The configurable retry frequency may include predetermined time intervals and/or a predetermined number of retry attempts. The time intervals and/or retry attempts may be configurable, e.g., by the requesting third-party application, the entity, etc. In some embodiments, if the application times out during the communication process, an error will be logged and a retry may be initiated.

In some embodiments, a key pair comprising a private key and public key may be generated for a third-party application. The public key may be provided to the third-party application to encrypt requests, portions of requests (e.g., authentication credentials), etc. The private key may be securely stored to decrypt encrypted elements received from the third-party application.

Advantageously, embodiments disclosed herein provide a subscription/notification model to securely integrate real-time status information into third-party applications. The subscription model may facilitate many-to-many subscriptions (e.g., many applications and/or devices can subscribe to many events), which improves conventional solutions which do not support real-time status information. Because only a secure server includes the keys required to decrypt information and/or validate information, the security and privacy of the status of an event is improved. Furthermore, embodiments disclosed herein allow any type of application and/or system to create subscriptions and receive notifications. Doing so improves conventional systems which required specific and manual configuration for a given type of application and/or system. Embodiments are not limited in these contexts.

Aspects of the present disclosure and certain features, advantages, and details thereof are explained more fully below with reference to the non-limiting examples illustrated in the accompanying drawings. Descriptions of well-known techniques, systems, components, etc., are omitted so as to not unnecessarily obscure the disclosure in detail. It should be understood that the detailed description and the specific examples, while indicating aspects of the disclosure, are given by way of illustration only, and not by way of limitation. Various substitutions, modifications, additions, and/or arrangements, within the spirit and/or scope of the underlying concepts will be apparent to those skilled in the art from this disclosure. Note further that numerous aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Like numbers refer to like elements throughout.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the disclosure. Therefore, it is to be understood that, within the scope of the included claims, the disclosure may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present disclosure can include fixed function hardware, while other embodiments can utilize a software-based implementation of the functionality described. Certain embodiments combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Reference is now made to the drawings, wherein like reference numerals are used to refer to like elements throughout.

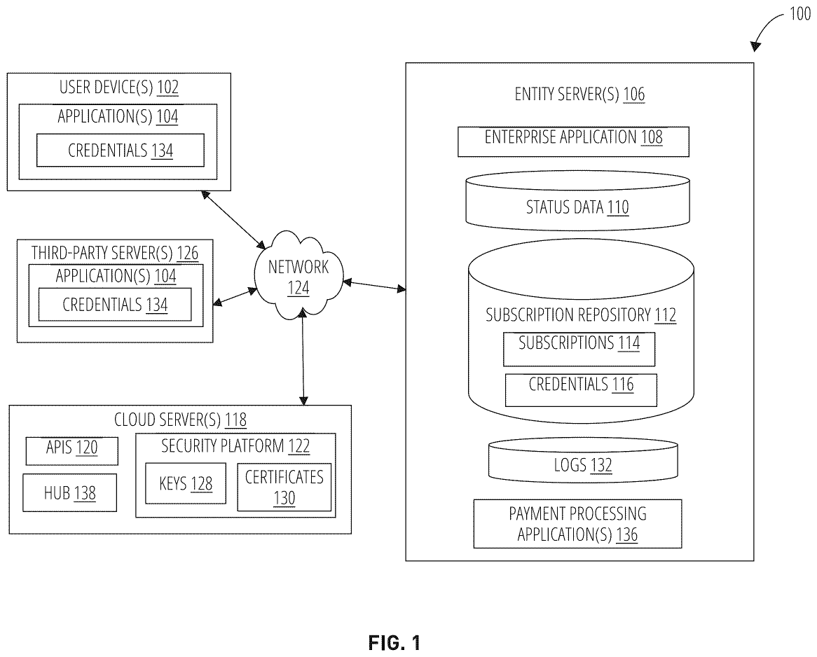

FIG. 1 illustrates a system 100 according to one embodiment. As shown, the system 100 includes one or more user devices 102, one or more entity servers 106 of an entity such as a financial institution, one or more cloud servers 118, and one or more third-party servers 126 communicably coupled via one or more networks 124. The user devices 102, entity servers 106, cloud servers 118, and third-party servers 126 are representative of any type of physical and/or virtualized computing system. The user devices 102, entity servers 106, cloud servers 118, and third-party servers 126 each include at least one processor for executing instructions and at least one memory for storing instructions, each not pictured for the sake of clarity.

As shown, the user devices 102 may execute one or more applications 104. At least one of the applications 104 executing on the user devices 102 may be developed by third parties associated with the third-party servers 126. Stated differently, third-party developers may provide one or more of the applications 104. Examples of such applications 104 include any type of application, such as enterprise resource planning (ERP) applications, productivity applications, games, mobile applications, video conferencing applications, audio conferencing applications, voice over internet protocol (VOIP) applications, soft phone applications, messaging applications, chatbots, email clients, web browsers, document editors, account management applications, mobile P2P payment system client applications, applications provided by financial institutions, financial applications, payment applications, network functions, Automated Clearing House (ACH) applications, FedNow payment applications, real-time payments (RTP) applications, monetary transfer applications, mobile wallet applications, accounting applications, payment processing frameworks, or any application that includes features to submit payments to one or more payment processing applications 136 of the entity servers 106 for processing. For example, a smartphone application 104 may have features that require payment before they can be accessed. When a user agrees to access a feature that requires payment, the user may provide payment (e.g., using a bank account, credit card, debit card, payment service, where payment services include automated clearing house (ACH) transfers, Zelle® transfers, wire transfers, etc.). The payments may generally be processed at least in part by one or more payment processing applications 136 of the entity servers 106. The payment processing applications 136 may be part of a payment processing network (not pictured). In some embodiments, the payment processing network includes the payment processing applications 136 as well as applications and/or systems of other entities (e.g., other financial institutions, etc.).

When an application 104 submits a payment transaction to the payment processing applications 136, the application 104 and/or payment processing applications 136 generate a unique transaction ID. The application 104 sends payment details, including the payer's account information and amount, to the payment processing applications 136. The payment processing applications 136 route the transaction through the payment processing network for authorization, verifying the payer's funds, ultimately returning an approval or decline response linked to the transaction ID. If approved, the payment processing applications 136 use the transaction ID to initiate settlement and reconciliation, transferring funds to the merchant's account and recording the transaction.

As shown, the applications 104 include a plurality of credentials 134 for one or more accounts. The credentials 134 may include a public key generated by an enterprise application 108 of the entity server 106 as part of a public/private key pair. The entity server 106 may store the corresponding private key as part of the credentials 116 for the accounts. The entity server 106 may generate authentication credentials for the application 104, e.g., login/password, an authentication token, etc., and encrypt the authentication credentials using the private key. The entity server 106 may transmit the encrypted credentials to the application 104, which may decrypt the encrypted credentials using the public key. The entity server 106 may store the unencrypted authentication credentials in the credentials 116, while the application 104 may store the decrypted authentication credentials in the credentials 134. The applications 104 are responsible for encrypting specific attributes of a given payload using the public key, ensuring both security and efficient processing.

The credentials 134 stored by the applications 104 further include an authentication token that is used to authenticate with the enterprise application 108 of the entity server 106. The authentication token may be secure in that it may be used to authenticate and/or expose sensitive attributes, e.g., account information, payment information, user information, etc. In some embodiments, the authentication token is generated based at least in part on the authentication credentials generated by the server. In some embodiments, the authentication token is generated using a hash function, encryption function, or any other suitable function.

Payment processing may include multiple phases, including but not limited to, security checks, fraud checks, confirming sufficient funds, settlement (e.g., transferring funds from the payor's account at the financial institution associated with the entity servers 106 to the target account), and reconciliation (e.g., confirming transaction accuracy and finalizing records). At each phase, the payment processing applications 136 may store indications of the payment processing, e.g., in the status data 110. The status data 110 may generally log the steps performed during the processing of a transaction (indexed by transaction ID).

Conventionally, however, due to security issues, applications 104 do not have visibility into transaction processing phases once submitted to the entity servers 106 for processing. For example, if a payment is delayed due to fraud checks, the applications 104 may not be aware of the status, as the financial institution may not want to expose the status data 110 to all applications 104, particularly applications 104 provided by third-party developers. Advantageously, however, the system 100 provides techniques to securely provide transaction status information to the applications 104. Stated differently, the applications 104 provide embedded finance capabilities, e.g., by extending portions of the payment processing phases by the entity servers 106 to the applications 104.

More specifically, the system 100 provides techniques to securely provide payment status information to the applications 104 using a subscription/synchronization model. The cloud servers 118 include a plurality of APIs 120 and a security platform 122 to facilitate the subscription/synchronization models. The APIs 120 may facilitate communications between the entities of the system 100. Although depicted as a single server, the APIs 120 and security platform 122 may be separated across multiple different cloud servers 118.

To subscribe to an event, e.g., a transaction being processed by the entity servers 106, an application 104 may generate a subscription request. The subscription request may specify an entity (e.g., a financial institution and/or service to process a payment), a callback link for the application 104 to receive responses (e.g., payment event updates), an identifier of the payment and/or transaction (e.g., an event), and an authentication token from the credentials 134. In some embodiments, the subscription request further includes encrypted authentication credentials. The application 104 may transmit the subscription request to a first API 120 of the cloud servers 118. The first API 120 may be associated with a cloud hub 138. One example of a cloud hub 138 is the MuleSoft® CloudHub.

The cloud hub 138 may then issue a request to the security platform 122 to encrypt the authentication token. In some embodiments, a call to a second API 120 is made to request encryption of the authentication token by the cloud hub 138. One example of a security platform 122 is Protegrity®. The security platform 122 may generally encrypt sensitive data, decrypt sensitive data, tokenize sensitive data, and/or detokenize sensitive data. For example, the application 104 and/or enterprise application 108 may use the security platform 122 to tokenize and detokenize sensitive attributes of the data, ensuring that any sensitive information is securely tokenized before transmission and detokenized only when necessary for downstream processing. Similarly, the application 104 and/or enterprise application 108 may use the security platform 122 to encrypt and decrypt sensitive attributes of the data, ensuring that any sensitive information is securely encrypted before transmission and decrypted only when necessary for downstream processing.

The security platform 122 may encrypt the authentication token using one or more keys. In some embodiments, the security platform 122 stores the encrypted authentication token. In other embodiments, the encrypted authentication token is not stored. The security platform 122 may store the one or more keys in the keys 128. In some embodiments, one or more certificates 130 are stored to verify the keys 128 and/or encrypted authentication token. In some embodiments, the keys 128 further include keys to tokenize and/or detokenize sensitive attributes of the data, ensuring that any sensitive information (e.g., payment information, authentication credentials, etc.) is securely tokenized before transmission and detokenized only when necessary for downstream processing. Advantageously, by storing the keys 128 and certificates 130 in the cloud servers 118 ensures the third-party developers of the applications 104 do not have access to the keys 128 and/or certificates 130 to maintain security and prevent unauthorized access to sensitive information. Furthermore, doing so allows the security platform 122 to possess the keys 128 and certificates 130 required to decrypt or otherwise access encrypted data sent by third-party applications 104, thereby ensuring secure handling and processing.

The security platform 122 may provide the encrypted authentication token to the cloud hub 138. The cloud hub 138 may then transmit the subscription request and the encrypted authentication token to the enterprise application 108. In some embodiments, the cloud hub 138 makes an API call to the enterprise application 108 to request the creation of the subscription. In some embodiments, the enterprise application 108 decrypts the encrypted authentication credentials in the request and validates the decrypted authentication credentials (e.g., verifying a username password, biometrics, token, etc.). The enterprise application 108 may then generate and store an indication of the requested subscription 114 in the subscription repository 112. The entry in the subscriptions 114 may include the request parameters and the encrypted authentication token (but not the unencrypted authentication token).

As the payment processing applications 136 process the transaction, one or more status updates may be stored in the status data 110 for the transaction. Doing so may cause a database trigger to execute, which may cause the enterprise application 108 to initiate the synchronization model. Generally, the enterprise application 108 may receive an indication of the transaction ID based on the update to the status data 110. The enterprise application 108 may then reference the subscription repository 112 to determine which entities are subscribed to the transaction ID along with the corresponding details to notify the subscribers of the status update. In some embodiments, the enterprise application 108 determines whether the event type in the status data 110 matches the event in the subscriptions 114. Doing so ensures only relevant notifications are returned to the requesting application 104 (e.g., to return processed payments rather than failed payments, etc.).

For example, the enterprise application 108 may receive the callback link and the encrypted authentication token of the application 104 subscribed to the transaction from the corresponding subscription 114. The enterprise application 108 may generate a response data package including the status data 110 for the transaction (e.g., transaction ID, payment processing status, amount, etc.), the callback link, and the encrypted authentication token. The enterprise application 108 may then make a call to an API 120 of the cloud hub 138 based on the response data package. The cloud hub 138 may receive the API call and the response data package. The cloud hub 138 may request the security platform 122 decrypt the encrypted authentication token and any encrypted attributes in the response data package. The security platform 122 then decrypts the authentication token and any encrypted attributes, and returns the decrypted authentication token and decrypted attributes to the cloud hub 138. The cloud hub 138 may then modify the response data package to include the decrypted authentication token and decrypted attributes (and not the encrypted versions of the token or attributes). The cloud hub 138 may then return the modified response data package to the application 104 at the callback link, which may allow the user to view the status update of the payment (e.g., accepted, cancelled, completed, saved for later, etc.).

In some embodiments, prior to sending any status updates, the enterprise application 108 may verify whether the developer associated with the application 104 is associated with a known or trusted developer, e.g., in the subscriptions 114. Therefore, entities that have not subscribed are denied access to the events in the status data 110.

In some embodiments, the synchronization workflow may include one or more retries, e.g., when a notification is not successfully transmitted to one or more subscribing applications 104, the enterprise application 108 may initiate one or more retries. The error may be logged in the logs 132 and automatically trigger one or more retries based on a configurable retry frequency maintained by the enterprise application 108. The configurable retry frequency may include predetermined time intervals and/or a predetermined number of retry attempts. The time intervals and/or retry attempts may be configurable, e.g., by the requesting third-party application, the entity, etc. In some embodiments, if the application 104 times out during the communication process, an error will be logged in the logs 132 and the enterprise application 108 may initiate a retry.

While the subscriptions 114 were described at the high level of a single transaction, the subscription may allow for more granular subscriptions. For example, an application 104 may register to approved transactions, rejected transactions, etc. Other types of events that can be subscribed to are depicted in Table I:

TABLE I
Event

payment.credit-transfer.status.accepted
payment.credit-transfer.status.cancelled
payment.credit-transfer.status.completed
payment.credit-transfer.status.expired
payment.credit-transfer.status.failed
payment.credit-transfer.status.processing
payment.credit-transfer.status.purged
payment.credit-transfer.status.rejected
payment.credit-transfer.status.savedforlater
payment.credit-transfer.status.softdeleted
payment.credit-transfer.status.submitted
payment.request-for-payment.status.accepted
payment.request-for-payment.status.acceptedbypayer
payment.request-for-payment.status.approvalexpired
payment.request-for-payment.status.approved
payment.request-for-payment.status.cancelationfailed
payment.request-for-payment.status.cancelationsent
payment.request-for-payment.status.cancelled
payment.request-for-payment.status.complete
payment.request-for-payment.status.Delivered
payment.request-for-payment.status.expirationfailed
payment.request-for-payment.status.expired
payment.request-for-payment.status.failed
payment.request-for-payment.status.needsapproval
payment.request-for-payment.status.paid
payment.request-for-payment.status.processed
payment.request-for-payment.status.processing
payment.request-for-payment.status.purged
payment.request-for-payment.status.received
payment.request-for-payment.status.rejected
payment.request-for-payment.status.rejectedbyapprover
payment.request-for-payment.status.rejectedbypayer
payment.request-for-payment.status.savedforlater
payment.request-for-payment.status.scheduled
payment.request-for-payment.status.softdeleted
payment.request-for-payment.status.submitted
payment.transfer.status.purged
payment.transfer.status.softdeleted
account.status.update
company.entitlement.status.update
user.entitlement.status.update

Advantageously, multiple applications 104 can subscribe to any number and type of events using the subscription repository 112. Similarly, when events occur during the processing of a transaction, the subscribers can each receive notifications on the events using the synchronization workflow.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 124 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 102 may include automatic teller machines (ATMs) utilized by the system 100 in serving users. In another example, the entity servers 106 represent payment clearinghouse or payment rail systems for processing payment transactions, and in another example, the entity servers 106 such as merchant systems or banking systems configured to interact with the user devices 102 during transactions and also configured to interact with the enterprise system 100 in back-end transactions clearing processes.

The user devices 102 may also be configured to obtain and process various forms of authentication via an authentication system to obtain authentication information of a user. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

System 100 as illustrated diagrammatically represents at least one example of a possible implementation, where alternatives, additions, and modifications are possible for performing some or all of the described methods, operations, and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized, or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 102) to serve users in their interactions to communicate and take action. In such embodiments, the user devices 102 can be, as non-limiting examples, computing devices, kiosks, terminals, smart devices such as phones, and devices and tools at customer service counters and windows at POS locations.

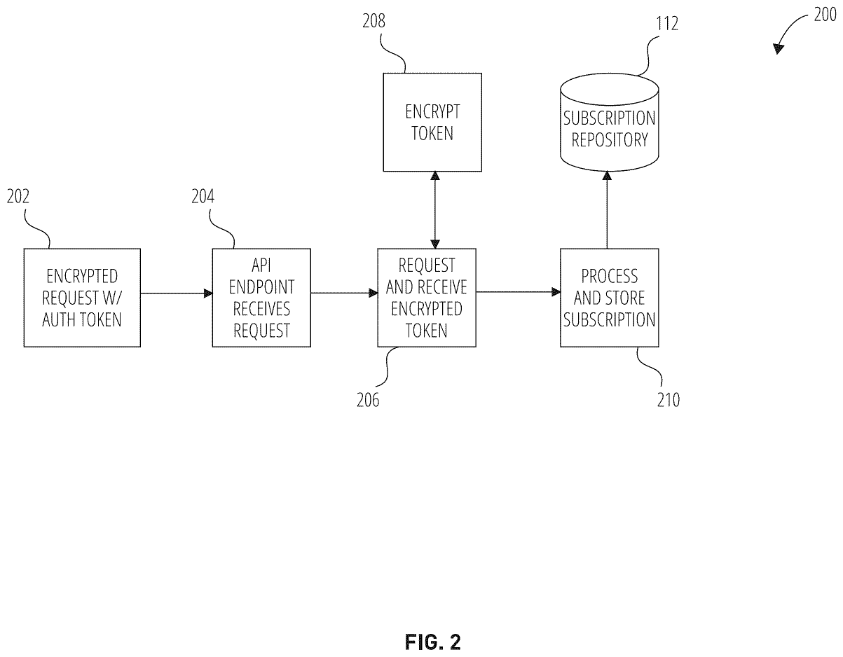

FIG. 2 illustrates a sequence diagram 200 for generating subscriptions in the subscriptions 114, according to one embodiment. As shown, at block 202, an application 104 may generate a subscription request with the unencrypted authentication token from the credentials 134. The subscription request may specify one or more events, a transaction ID, and a callback link. One or more attributes of the request may be encrypted using the public key from the credentials 134. At block 204, the cloud hub 138 may receive the request from the application 104. At block 206, the cloud hub 138 may request the security platform 122 encrypt the authentication token. At block 208, the security platform 122 encrypts the authentication token and transmits the encrypted authentication token to the cloud hub 138. The cloud hub 138 may then transmit the request with the encrypted authentication token to the enterprise application 108. At block 210, the enterprise application 108 may process the request and store an indication of a subscription 114 in the subscription repository 112. For example, the subscription 114 may include indications of the callback link, the encrypted authentication token, the event(s) subscribed to, and the transaction ID.

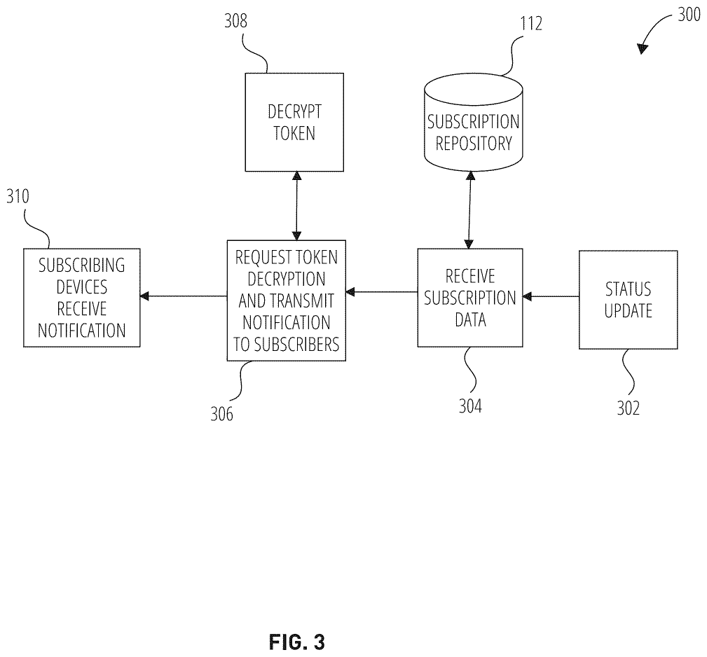

FIG. 3 illustrates a sequence diagram 300 for the synchronization workflow to push notifications to subscribing applications, according to one embodiment. As shown, at block 302, a status update for a transaction may be stored in the status data 110. For example, the payment processing applications 136 may process a payment, reject a payment, hold the transaction, etc., and store an indication of the same in the status data 110. Doing so creates a trigger with the transaction ID and relevant attributes from the status data 110 to the enterprise application 108 at block 304. At block 304, the enterprise application 108 references the subscription repository 112 using the transaction ID. Doing so may return one or more subscriptions 114 to the enterprise application 108. The enterprise application 108 may generate a response data package including the status data 110 and the subscription 114 data for each identified subscription 114 in the subscription repository 112. Any sensitive data in the response package may be encrypted using the private key.

The enterprise application 108 may provide the response package to the cloud hub 138 at block 306. The cloud hub 138 may request the security platform 122 decrypt the encrypted authentication token in the response package. The security platform 122 may decrypt the encrypted authentication token and return the decrypted authentication token to the cloud hub 138 at block 308. The cloud hub 138 may then replace the encrypted authentication token in the response package with the decrypted authentication token and transmit the response package to the application 104 at the callback link. Doing so allows the subscribing applications 104 receive the response packages at block 310.

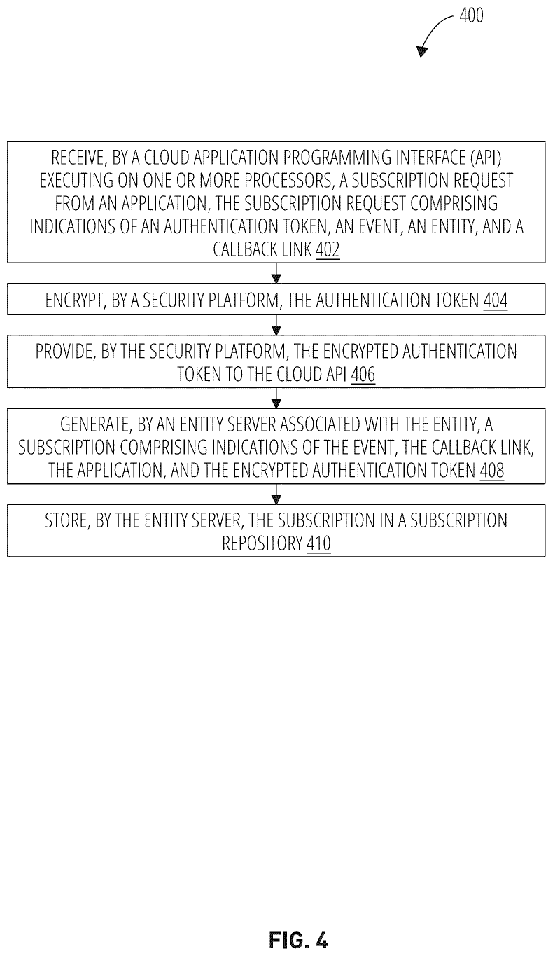

FIG. 4 illustrates an example logic flow 400 for generating subscriptions in the subscription repository 112. Although the example logic flow 400 depicts a particular sequence of operations, the sequence may be altered without departing from the scope of the present disclosure. For example, some of the operations depicted may be performed in parallel or in a different sequence that does not materially affect the function of the logic flow 400. In other examples, different components of an example device or system that implements the logic flow 400 may perform functions at substantially the same time or in a specific sequence.

According to some examples, the logic flow 400 includes receiving, by a cloud application programming interface (API) executing on one or more processors, a subscription request from an application, the subscription request comprising indications of an authentication token, an event, an entity, and a callback link at block 402. For example, the cloud hub 138 illustrated in FIG. 1 may receive a subscription request from an application 104, the subscription request comprising indications of an authentication token, an event (e.g., processed transactions), an entity, and a callback link.

According to some examples, the logic flow 400 includes encrypting, by a security platform, the authentication token at block 404. For example, the security platform 122 illustrated in FIG. 1 may encrypt the authentication token.

According to some examples, the logic flow 400 includes providing, by the security platform, the encrypted authentication token to the cloud hub at block 406. For example, the security platform 122 illustrated in FIG. 1 may provide the encrypted authentication token to the cloud hub 138 via one or more APIs 120.

According to some examples, the logic flow 400 includes generating, by an entity server associated with the entity, a subscription comprising indications of the event, the callback link, the application, and the encrypted authentication token at block 408. For example, the entity server 106 illustrated in FIG. 1 may generate a subscription 114 comprising indications of the event, the callback link, the application, and the encrypted authentication token.

According to some examples, the logic flow 400 includes storing, by the entity server, the subscription in a subscription repository at block 410. For example, the entity server 106 illustrated in FIG. 1 may store the subscription 114 in a subscription repository 112.

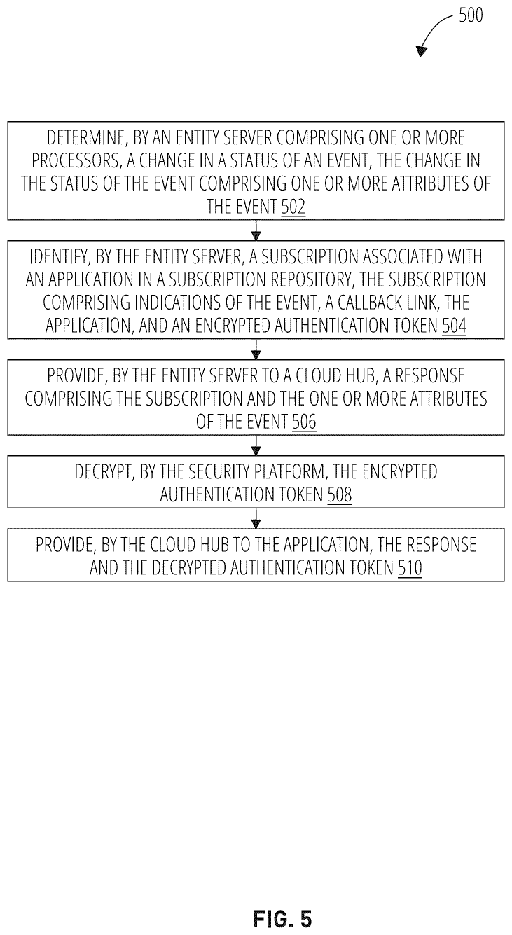

FIG. 5 illustrates an example logic flow 500 for a synchronization workflow to push notifications to subscribing applications, according to one embodiment. Although the example logic flow 500 depicts a particular sequence of operations, the sequence may be altered without departing from the scope of the present disclosure. For example, some of the operations depicted may be performed in parallel or in a different sequence that does not materially affect the function of the logic flow 500. In other examples, different components of an example device or system that implements the logic flow 500 may perform functions at substantially the same time or in a specific sequence.

According to some examples, the logic flow 500 includes determining, by an entity server comprising one or more processors, a change in a status of an event, the change in the status of the event comprising one or more attributes of the event at block 502. For example, the enterprise application 108 illustrated in FIG. 1 may determine a change in a status of an event, the change in the status of the event comprising one or more attributes of the event. For example, during processing of a transaction, the payment processing applications 136 may store different events associated with the transaction processing in the status data 110. Doing so may cause a database trigger to be sent to the enterprise application 108 reflecting the added event to the status data 110.

According to some examples, the logic flow 500 includes identifying, by the entity server, a subscription associated with an application in a subscription repository, the subscription comprising indications of the event, a callback link, the application, and an encrypted authentication token at block 504. For example, the enterprise application 108 illustrated in FIG. 1 may identify a subscription 114 associated with an application 104 in the subscription repository 112. The subscription 114 comprises indications of the event, a callback link, the application, and an encrypted authentication token.

According to some examples, the logic flow 500 includes providing, by the entity server to a cloud hub, a response comprising the subscription and the one or more attributes of the event at block 506. For example, the enterprise application 108 illustrated in FIG. 1 may provide, to the cloud hub 138, a response data package comprising the subscription 114 (e.g., the event, the callback link, the application, and the encrypted authentication token) and/or the one or more attributes of the event from the status data 110.

According to some examples, the logic flow 500 includes decrypting, by the security platform, the encrypted authentication token at block 508. For example, the security platform 122 illustrated in FIG. 1 may decrypt the encrypted authentication token based on a request received from the cloud hub 138. The decrypted authentication token may be returned by the security platform 122 to the cloud hub 138.

According to some examples, the logic flow 500 includes providing, by the cloud hub to the application, the response and the decrypted authentication token at block 510. For example, the cloud hub 138 illustrated in FIG. 1 may provide, to the application 104 at the callback link, the response and the decrypted authentication token.

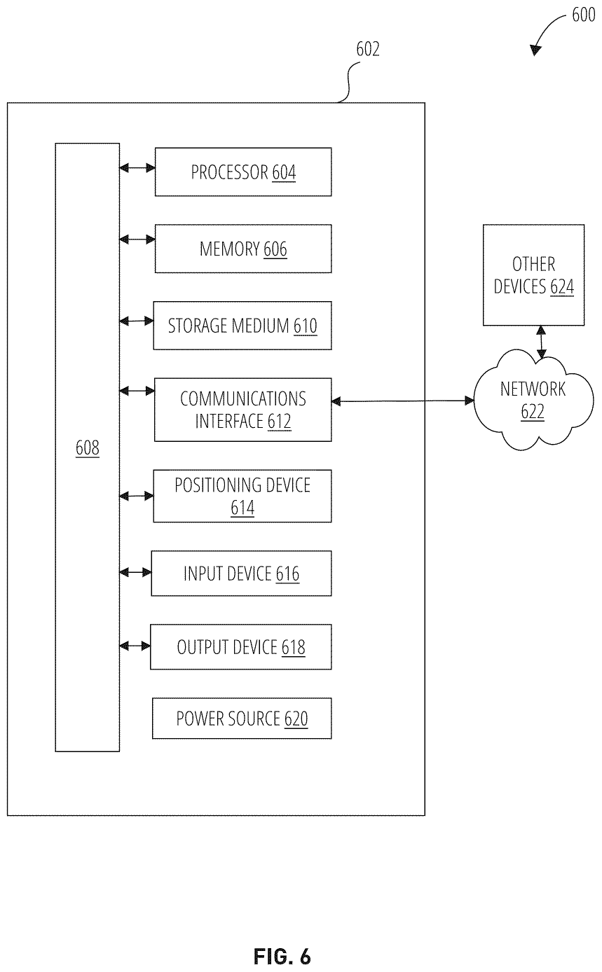

FIG. 6 illustrates an example computing system 600 suitable for implementing various embodiments as described herein. As shown, the computing system 600 comprises a computer 602, which is representative of any type of physical and/or virtualized computing device. Examples of the computer 602 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 602 is representative of some or all of the components of system 100, including the user devices 102, entity servers 106, cloud servers 118, and third-party servers 126. More generally, the computing system 600 is configured to implement all systems, methods, apparatuses, media, and embodiments disclosed herein.

As shown, the computer 602 includes one or more processors 604, one or more memories 606, one or more non-transitory storage media 610, one or more communications interfaces 612, one or more positioning devices 614, one or more input devices 616, and one or more output devices 618 communicably coupled via an interconnect 608. A power source 620, such as a power supply, battery, or any type of power source may provide power to the computer 602.

The processor 604 is representative of any type of processing circuit. For example, the processor 604 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 606 is representative of any computer readable medium to store data, code, or other information. The memory 606 may include volatile memory, such as volatile Random Access Memory (RAM) including a cache area for the temporary storage of data. The memory 606 may also include non-volatile memory, which can be embedded and/or may be removable. The non-volatile memory can additionally or alternatively include an electrically erasable programmable read-only memory (EEPROM), flash memory or the like. The storage medium 610 is representative of any type of computer readable medium to store data, code, or other information. Examples of storage media 610 include solid state drives, hard drives, Redundant Array of Independent Disks (RAID) drives, memory pools, USB storage devices, and the like.

The memory 606 and storage medium 610 can store any number and type of computer-executable instructions executed by the processor 604 to implement the functions of the computer 602 described herein. For example, the memory 606 may include such applications as a web browser application and/or a mobile P2P payment system client application. These applications also typically provide a graphical user interface (GUI) on a display that allows the user to communicate with the computer 602, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 606 and/or storage medium 610 may be used to store data such as cached data, files for user accounts, user profiles, account balances, transaction histories, files downloaded or received from other devices, and any other data items.

The interconnect 608 is representative of any type of circuitry to connect the components of the computer 602. For example, the interconnect 608 can include or represent, a system bus, a universal serial bus (USB) interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 604 to the memory 606, individual electrical connections among the components, and electrical conductive traces on a motherboard common to some or all of the above-described components of the computer 602. As discussed herein, the interconnect 608 may operatively couple various components with one another, or in other words, electrically connects those components, either directly or indirectly
by way of intermediate component(s)—with one another.

The one or more input devices 616 are representative of any type of input device for receiving input, such as a keypad, keyboard, touchscreen, touchpad, microphone, camera, fingerprint sensor, mouse, joystick, other pointer device, button, soft key, and the like. The one or more output devices 618 are representative of any type of device for outputting information, such as a monitor, speaker, haptic feedback module, printer, and the like.

The computer 602 may use the communications interface 612 to communicate with one or more other devices 624 via a network 622. The communications interface 612 allows the computer 602 to communicate with and conduct transactions with other devices and systems, such as the other devices 624. The communications interface 612 may be a wired and/or a wireless interface. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communications interface 612, which can be or include a radio-frequency transceiver, a Bluetooth device, Wi-Fi device, a Near-Field Communication (NFC) device, and other wireless transceivers. In addition, a positioning device 614 such as a Global Positioning System (GPS) device may be included for navigation and location-related data exchanges, ingoing and/or outgoing. Wi-Fi networks use radio technologies called IEEE 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). Communications may also and/or alternatively be conducted via wired connections using the communications interface 612, e.g., using USB, Ethernet, and other physically connected modes of data transfer. The network 622 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 602 is configured to use the communications interface 612 as, for example, a network interface to communicate with one or more other devices on a network such as network 622. In this regard, the computer 602 utilizes the wireless communications interface 612 as an antenna operatively coupled to a transmitter and a receiver (together a “transceiver”) included with the communications interface 612. The communications interface 612 is configured to provide signals to and receive signals from the transmitter and receiver, respectively. The signals may include signaling information in accordance with the air interface standard of the applicable cellular system of a wireless telephone network. In this regard, the computer 602 may be configured to operate with one or more air interface standards, communication protocols, modulation types, and access types. By way of illustration, the computer 602 may be configured to operate in accordance with any of a number of first, second, third, fourth, fifth-generation communication protocols and/or the like. For example, the as a smartphone, the computer 602 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 602 may also be configured to operate in accordance with non-cellular communication mechanisms, such as via a wireless local area network (WLAN) or other communication/data networks.

The communications interface 612 may also include a payment network interface. The payment network interface may include software, such as encryption software, and hardware, such as a modem, for communicating information to and/or from one or more devices on a network. For example, the computer 602 may be configured so that it can be used as a credit or debit card by, for example, wirelessly communicating account numbers or other authentication information to a terminal of the network. Such communication could be performed via transmission over a wireless communication protocol such as the NFC protocol.

The computer 602 may be under the control of any suitable operating system (not pictured). Example operating systems include, but are not limited to, Linux® operating systems, UNIX®, Windows® operating systems, macOS®, iOS®, Android® and any other type of operating system.

The computer 602 as illustrated diagrammatically represents at least one example of a possible implementation, where alternatives, additions, and modifications are possible for performing some or all of the described methods, operations, and functions. Although shown separately, in some embodiments, two or more computers 602, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
receiving, by a cloud application programming interface (API) executing on one or more processors, a subscription request from an application, the subscription request comprising indications of an authentication token, an event, an entity, and a callback link;
encrypting, by a security platform, the authentication token;
providing, by the security platform, the encrypted authentication token to the cloud API;
generating, by an entity server associated with the entity, a subscription comprising indications of the event, the callback link, the application, and the encrypted authentication token;
storing, by the entity server, the subscription in a subscription repository.

2. The method of claim 1, further comprising:
determining, by the entity server, a change in a status of the event, the change in the status of the event comprising one or more attributes of the event;
receiving, by the entity server based on the change in the status of the event, the subscription from the subscription repository;
providing, by the entity server to the security platform, a response comprising the subscription and the one or more attributes of the event; and
decrypting, by the security platform, the encrypted authentication token; and
providing, by the security platform to the application, the response and the decrypted authentication token.

3. The method of claim 2, wherein the response and the decrypted authentication token are provided to the application via the callback link.

4. The method of claim 1, further comprising prior to receiving the subscription request:
generating, by the entity server, a key pair comprising a public key and a private key; and
transmitting, by the entity server, the public key to the application.

5. The method of claim 4, wherein the application encrypts authentication credentials of the subscription request based on the public key.

6. The method of claim 5, further comprising prior to generating the subscription:
decrypting, by the entity server the encrypted authentication credentials with the private key; and
validating, by the entity server, the decrypted authentication credentials, wherein the entity server generates the subscription based on the decryption and validation of the authentication credentials.

7. The method of claim 1, wherein the event comprises a payment event processed at least in part by the entity, wherein the application is associated with a third-party developer, wherein the third-party developer is distinct from the entity.

8. A non-transitory computer-readable storage medium, the computer-readable storage medium including instructions that when executed by one or more processors, cause the one or more processors to:
receive, by a cloud application programming interface (API), a subscription request from an application, the subscription request comprising indications of an authentication token, an event, an entity, and a callback link;
encrypt, by a security platform, the authentication token;
provide, by the security platform, the encrypted authentication token to the cloud API;
generate, by an entity server associated with the entity, a subscription comprising indications of the event, the callback link, the application, and the encrypted authentication token;
store, by the entity server, the subscription in a subscription repository.

9. The computer-readable storage medium of claim 8, wherein the instructions further cause the one or more processors to:
determine, by the entity server, a change in a status of the event, the change in the status of the event comprising one or more attributes of the event;
receive, by the entity server based on the change in the status of the event, the subscription from the subscription repository;
provide, by the entity server to the security platform, a response comprising the subscription and the one or more attributes of the event; and
decrypt, by the security platform, the encrypted authentication token; and
provide, by the security platform to the application, the response and the de crypted authentication token.

10. The computer-readable storage medium of claim 9, wherein the response and the decrypted authentication token are provided to the application via the callback link.

11. The computer-readable storage medium of claim 8, wherein the instructions further cause the one or more processors to, prior to receiving the subscription request:
generate, by the entity server, a key pair comprising a public key and a private key; and
transmit, by the entity server, the public key to the application.

12. The computer-readable storage medium of claim 11, wherein the application encrypts authentication credentials of the subscription request based on the public key.

13. The computer-readable storage medium of claim 12, wherein the instructions further cause the one or more processors to, prior to generating the subscription:
decrypt, by the entity server the encrypted authentication credentials with the private key; and
validate, by the entity server, the decrypted authentication credentials, wherein the entity server generates the subscription based on the decryption and validation of the authentication credentials.

14. The computer-readable storage medium of claim 8, wherein the event comprises a payment event processed at least in part by the entity, wherein the application is associated with a third-party developer, wherein the third-party developer is distinct from the entity.

15. A system, comprising:
one or more processors; and
a memory storing instructions that, when executed by the one or more processors, cause the one or more processors to:
receive, by a cloud application programming interface (API), a subscription request from an application, the subscription request comprising indications of an authentication token, an event, an entity, and a callback link;
encrypt, by a security platform, the authentication token;
provide, by the security platform, the encrypted authentication token to the cloud API;
generate, by an entity server associated with the entity, a subscription comprising indications of the event, the callback link, the application, and the encrypted authentication token;
store, by the entity server, the subscription in a subscription repository.

16. The system of claim 15, wherein the instructions further cause the one or more processors to:
determine, by the entity server, a change in a status of the event, the change in the status of the event comprising one or more attributes of the event;
receive, by the entity server based on the change in the status of the event, the subscription from the subscription repository;
provide, by the entity server to the security platform, a response comprising the subscription and the one or more attributes of the event; and
decrypt, by the security platform, the encrypted authentication token; and
provide, by the security platform to the application, the response and the decrypted authentication token.

17. The system of claim 16, wherein the response and the decrypted authentication token are provided to the application via the callback link.

18. The system of claim 15, wherein the instructions further cause the one or more processors to, prior to receiving the subscription request:
generate, by the entity server, a key pair comprising a public key and a private key; and
transmit, by the entity server, the public key to the application.

19. The system of claim 18, wherein the application encrypts authentication credentials of the subscription request based on the public key, wherein the instructions further cause the one or more processors to, prior to generating the subscription:
decrypt, by the entity server the encrypted authentication credentials with the private key; and
validate, by the entity server, the decrypted authentication credentials, wherein the entity server generates the subscription based on the decryption and validation of the authentication credentials.

20. The system of claim 15, wherein the event comprises a payment event processed at least in part by the entity, wherein the application is associated with a third-party developer, wherein the third-party developer is distinct from the entity.
